(19) United States
(12) Patent Application Publication
(10) Pub. No.: US 2017/0258098 A1
(43) Pub. Date: Sep. 14, 2017

(54) Oval, Cone Shaped Edible Container for Food Items

(71) Applicant: Frederic Grayson Vogler, Clemmons, NC (US)

(72) Inventor: Frederic Grayson Vogler, Clemmons, NC (US)

(21) Appl. No.: 15/585,197

(22) Filed: May 3, 2017

Related U.S. Application Data
(63) Continuation-in-part of application No. 14/694,892, filed on May 15, 2015.

(51) Int. Cl. A21D 13/33; A21D 13/42

(52) U.S. Cl. CPC A21D 13/33; A21D 13/42

(57) ABSTRACT

A conically shaped rigid taco shell or edible container, formed from a pre-made, initially flat commercially available circular tortilla is formed by baking or deep frying the tortilla within the appropriate molds. The resulting elongated or oblong oval top opening provides a tidy, convenient, and easy to handle package for eating typical taco ingredients or other food products. The edible container can have either a symmetrical or arc shaped cross section.

### CROSS REFERENCE TO PRIOR CO-PENDING APPLICATION

This application is a continuation in part of prior co-pending application Ser. No. 14/694,892 filed on May 15, 2015.

### BACKGROUND OF THE INVENTION

The invention pertains to the shape and method of manufacturing of an edible food container used for the purpose of serving typical taco ingredients such as beef, chicken, shrimp, lettuce, tomato, refried beans, rice, sour cream and cheese.

The conventional taco shell design, that is being “U” shaped and formed from a circular corn-based tortilla, has obvious shortcomings that become apparent while eating such a taco. It must be held level and upright to minimize the spillage of ingredients. However, ingredients will inevitably spill out as one bites into the conventional taco. The consumer must twist their neck and turn their head sideways while eating so as to minimize further spilling of contents. Also the untidy nature of eating the conventional taco makes it unsuitable for consuming while being inside a motor vehicle or while wearing expensive apparel. The conventional taco shell is not very robust and will likely break with the slightest amount of pressure being applied to it's sides.

The conically shaped taco shell design with it's circular opening is not the ideal solution to a better alternative than the conventionally shaped taco shell. L. P. Smietana, U.S. Pat. No. 4,915,964 and N. G. Taminich, U.S. Pat. 2008/0220131A1, both present such a design. The average human adult mouth, much less that of a child, is not capable of opening wide enough to encompass both sides of a conically shaped taco shell, that is unless the conical shell has a small opening at the top. In order for the human mouth to fully encompass the top opening, this opening could be no larger than 1½″ in diameter. This size opening would be too small to make practical the filling of the various taco ingredients. If the opening of the conically shaped taco shell is larger than 1½″ in diameter and one bites into just one side of the taco cone, it is likely that their nose will come in contact with the taco ingredients. This would not be desirable to most people and thus the conically shaped taco shell is not a better alternative to the untidy process of eating the conventionally shaped taco. Also, packaging a conically shaped taco shell would require more space to accommodate the larger dimension of the circular opening of the shell.

Although the design by D. J. DiPietro, U.S. Pat. Des. 292,940 is similar in shape to the design presented here in this application, he does not offer any description or explanation as to the method of manufacture of his taco shell design. There are no lines present in his drawing, FIG. 1, that would indicate an overlapping section formed by using a circular tortilla. In viewing his visual depiction, one must conclude that this shell consists of a solid and continuous body which can only be formed by means of injecting a mixture of ingredients at a state of fluidity into a mold and then dried and hardened by an undescribed method. This process of injection molding is neither convenient or feasible as a method of manufacturing within a restaurant kitchen environment.

### BRIEF SUMMARY OF THE INVENTION

An edible container in which food items are disposable for consumption with the edible container is formed form an initially flat tortilla. The initially flat circular tortilla is formed into a conical configuration with an oval cross section expanding from a lower tip to an open mouth at an upper end. The tortilla being is folded so that a first side of the tortilla is folded over a second side of the tortilla so that food items can be disposed within the conical pocket of the edible container The folded first and second sides of the tortilla continue to the open mouth with both of the folded first and second sides forming an upper front lip of the mouth lower than an intermediate central section forming a rear, elevated lip of the mouth. Foot food items disposed in the edible container will be visible and accessible over the folded first and second sides, but supportable by the edible container in front of the rear, elevated lip. The invention is also directed to a food product with the food items disposed within the conical shaped tortilla. The oval shape makes it easier for a person to eat this item than would a cone shaped container with a circular cross section, which would not conform as closely to the shape of a human mouth.

One version of this edible container in which food items are disposable for consumption with the edible container is formed for an initially flat piece of dough folded into an overlapping configuration having an open mouth. The container has an oblong pocket extending from the open mount into which the food items are disposable. This version of the edible container is arc shaped and the oblong pocket has a concave inner surface extending between opposite ends of the oblong pocket, and a convex inner surface, spaced from the inner surface, and also extending between opposite ends of the oblong pocket. The concave inner surface and the concave inner surface are formed by portions of the piece of dough in the overlapping configuration, wherein the edible container conforms more closely to a human mouth than would a circular cross section so that it is easier to eat the edible container and food items in the edible container, and conforming to a user's hands when griping the edible container.

### BRIEF DESCRIPTION OF DRAWINGS

The drawings are not of actual size and are not drawn to scale.

FIG. 1: Front view of the elongated oval taco shell.

FIG. 2: Back view of the elongated oval taco shell.

FIG. 3: Right side view of the elongated oval taco shell.

FIG. 4: Top view of the elongated oval taco shell.

FIG. 5: Depicts cooking oil being sprayed on a circular tortilla.

FIG. 6: Depicts the tortilla being wrapped around an internal mold.

FIG. 7: Depicts continued wrapping of the tortilla around the internal mold.

FIG. 8: Depicts the internal mold with the surrounding tortilla being lowered into the external mold.

FIG. 9: Right side view of the internal mold, tortilla, and external mold, assembled and ready for cooking.

FIG. 10: Top view of the internal mold, tortilla, and external mold after assembly.

FIG. 11: Depicts the shape of the sheet metal used to fabricate the molds.

FIG. 12: Front view of the mold after fabrication.

FIG. 13: Side view of the mold after fabrication.

FIG. 14: Top view of the mold after fabrication.

FIG. 15: A three dimensional view of the internal mold, tortilla, and external mold being assembled and ready for cooking.

FIG. 16: Depicts a rack system which may be used for deep frying multiple elongated oval taco shells.

FIG. 17: A three dimensional view of the arc shaped elongated oval taco shell.

FIG. 18: Top view of the arc shaped elongated oval taco shell.

FIG. 19: A three dimensional view of a child's hands holding the arc shaped elongated oval taco ready for eating.

### DETAILED DESCRIPTION OF THE PREFERRED EMBODIMENTS

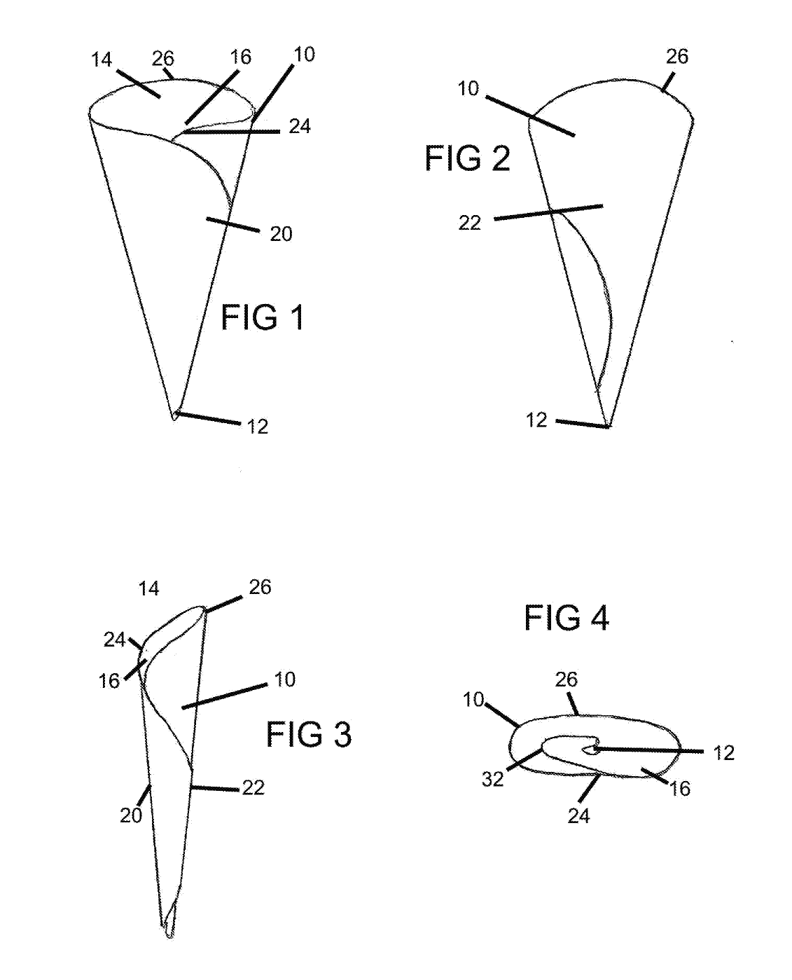

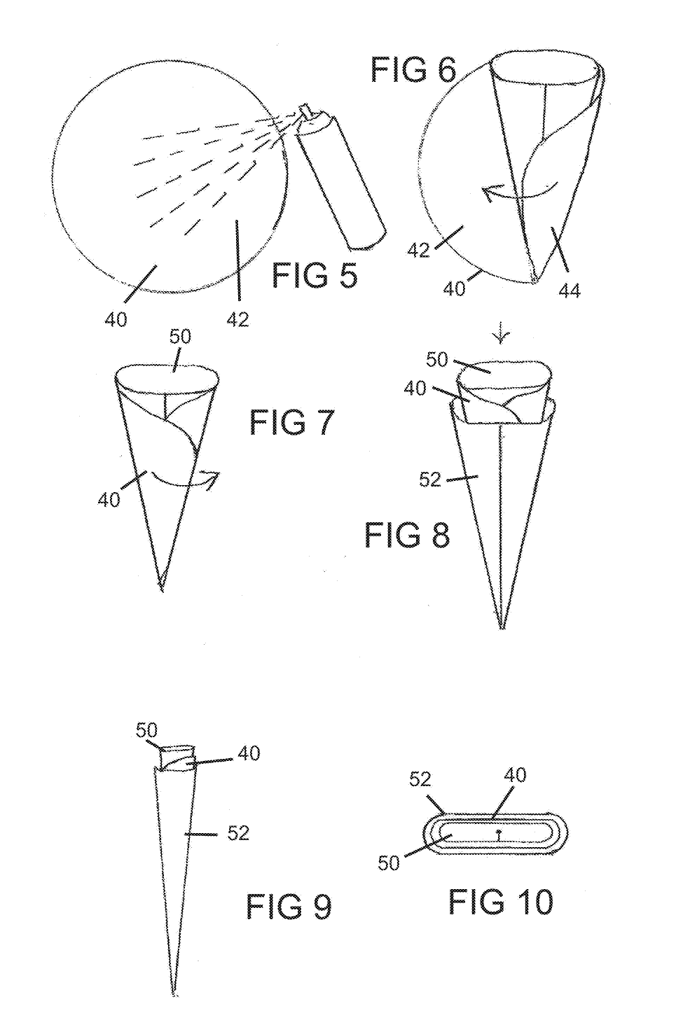

The final shape of the edible container or taco shell 10 with the elongated oval opening or open mouth 14 is shown in FIG. 1 thru FIG. 4. A single edible container 10 can be formed using a single circular, flat conventional tortilla or piece of dough 40 with a constant thickness. Depicted in FIG. 1 is an upright and frontal view showing where the first, left front side 42 of the tortilla 40 overlapping a second right side 44 , when formed to create a “V” shaped front portion or upper front lip 24 of the mouth 14 in the front face 20 of the edible container or taco shell 10. The resulting overall height is approximately 8″. The point where the “V” shape of the mouth 14 is formed is approximately 1½″ lower than the top back lip 26 of the edible container 10. The width of the opening or mouth 14 at the top is approximately 4″. The depth of the top opening or mouth 14 measured front to back is approximately 1″. The sides of the edible container 10 are rounded with their radius decreasing from top to bottom. Overall dimensions of the elongated oval taco shell container 10 may be changed depending on the choice and amount of food contents or items 4 or whether it is intended as a child's portion. Beef, chicken, shrimp, and fish, along with lettuce, tomato, sour cream, refried beans, cheese and rice being some of the food options. FIG. 2 illustrates the rear view and depicts where the front face 20 of the tortilla, when folded, partially overlaps the rear face 22. FIG. 3 illustrates the side view and overlapping area. FIG. 4 illustrates the top view as if looking straight down into the pocket 16 of the taco shell edible container 10. The elongated oval shape becomes most apparent in this view. It also depicts the inside edge 32 of the edible container 10 as it comes to a point or tip 12 at the bottom of the pocket 16.

Food items 4 placed in the edible container or shell 10 are visible because of the lower elevation of the V-shaped lower front lip 24. The elevated rear lip 26 provides support for the food items disposed within the pocket 16, and a person can orient the front and back of the edible shell for convenience so that the food items 4 are accessible when eating, and when tilted, the elevated rear lip 26 will support and hold the food items 4 in the pocket 16.

The elongated oval or oblong edible container or taco shell 10 is formed from a pre-made circular tortilla 40 of constant thickness which is approximately 8″ in diameter of the type available at grocery stores. The ingredients from which the tortilla 40 is made, whether they include wheat, corn, or flour, are not critical to the process of forming the tortilla 40 into the elongated oval shape. It is meaningful only as a preference in taste by the consumer. It is only necessary that the tortilla 40 be pliable enough to conform to the oval shape of the internal mold 50. See FIG. 6 and FIG. 7.

To form the oval shaped edible container 10, the tortilla 40 is first laid down flat on a counter top. A thin film of cooking oil is then applied to opposite sides 42, 44 of the tortilla 40, either by brush or spray method. This thin coating of oil will facilitate easy removal of the shell 10 from the molds 50, 52 when the cooking process is finished. This coating of oil will also help adhere the back side 22 to the overlapping front side 20 in the overlapping sections when the tortilla 40 is formed into the conical container or shell 10. An internal mold 50, as shown in FIG. 6, is placed on the tortilla 40 with it's point being flush with the bottom edge of the tortilla 40 and it's center axis in line with the center axis of the tortilla. See FIG. 6. The edge of the tortilla 40 is then lifted on one side and wrapped over the internal mold 50. See FIG. 6. Then the other side of the tortilla is lifted and wrapped over the other layer. See. FIG. 7. The internal mold 50 along with the surrounding tortilla 40 is then lowered into the external mold 52. See FIG. 8. The side view of this assembly is illustrated in FIG. 9. The top view of this configuration is illustrated in FIG. 10. At this point, the tortilla 40 is ready for the cooking process. It is a matter of consumer preference as to which cooking method is used. Whether baked, fried or deep fried, each method will result in a rigid and crisp shell or edible container 10 suitable for serving taco ingredients 4.

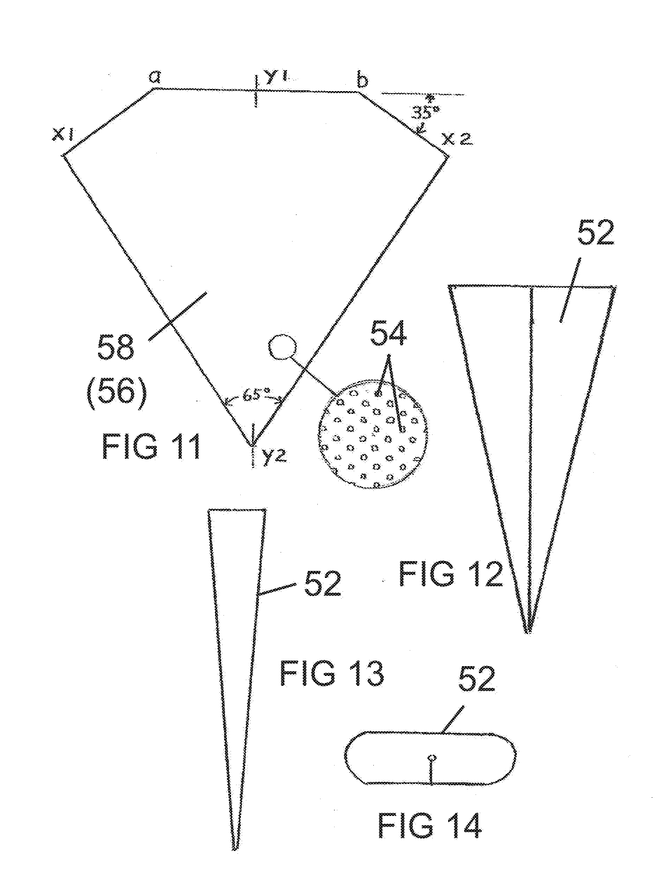

The use of internal and external molds 50, 52 are required to maintain the desired oval shape of the tortilla 40 as it is cooked to a rigid state forming the shell or container 10. If the deep frying process is used, then it is preferable that the molds 50, 52 be fabricated from a perforated sheet of stainless steel. These perforations 54 are indicated in FIG. 11. Stainless steel is a preferred material to be used in this application as it conducts heat well, is easy to clean, is more rigid than aluminum, and is not prone to rust. The perforations 54 allow for the uninhibited flow of hot oil around the inner and outer sides of the tortilla 40 to ensure even cooking of the shell while submerged in the bath of hot oil. The holes or perforations 54 in the stainless steel plate 56 can be approximately 1/16″ in diameter and number approximately 70 per square inch. Plate thickness should be 24 gage (0.025″). The dimensions of the plate 58 used to fabricate the external mold 52 are in reference to FIG. 11. The measurement along the x axis from point x1 to point x2 equals 9½″. Measurement along the y axis from point y1 to point y2 equals 9″. The top edge of the plate from point a to point b equals 5¼″. Angles at points a and b measure 35 degrees. Angle at point y2 measures 65 degrees. Segment a to x1 measures 2¾″. Segment b to x2 measures 2¾″ Segment x1 to y2 measures 9″. Segment x2 to y2 measures 9″. The stainless steel perforated plate 58 with such described dimensions is then bent and fashioned into the shape of a somewhat flattened cone forming an apex at the bottom and an elongated oval opening at the top as depicted in FIG. 12, FIG. 13, and FIG. 14. The top opening of the mold should measure 4″ wide, (side to side), and 1″ thick, (front to back). The center line in FIG. 12 that is from the center point of the top edge down to the apex depicts where the two sides of the plate edges come together. The rigidity of the 24 gage stainless steel will enable the mold to hold it's proper shape without needing to fasten these edges together. FIG. 13 illustrates the side view of the external mold. FIG. 14 illustrates the top view as looking down into the opening. The line from the center point to the front edge depicts where the edges of the mold meet at the front.

The internal mold 50 is made from the same material and is bent and fashioned into the same shape as the external mold 52 except that it's overall dimensions are smaller to allow space for the tortilla 40 that will be positioned between the two molds. The stainless steel perforated plate 56 to be used for the internal mold will be sized ¼″ less around the perimeter of the plate illustrated in FIG. 11. The opening of the completed internal mold should measure approximately 3¾″, (side to side), and approximately ¾″, (front to back).

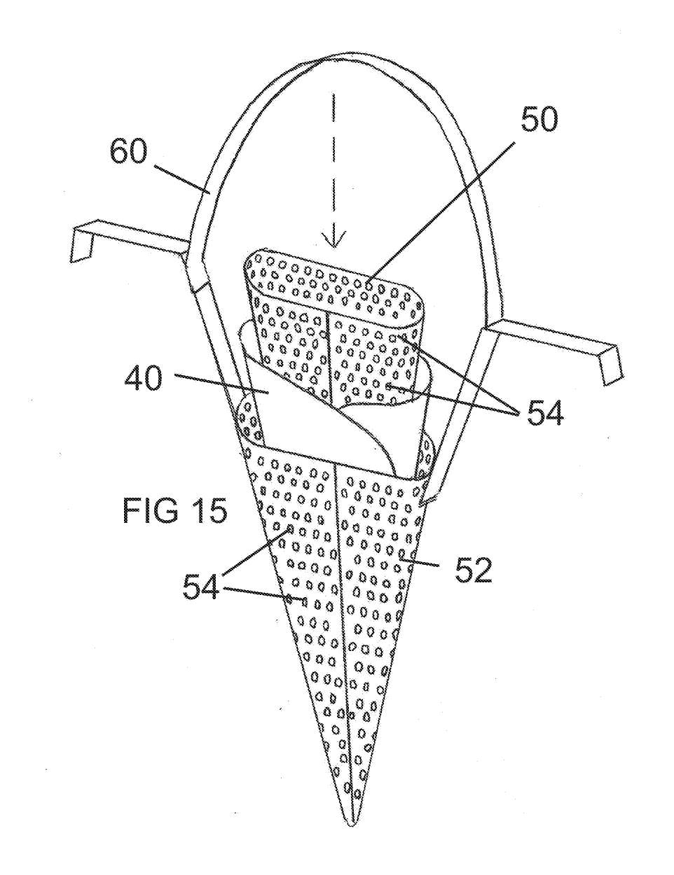

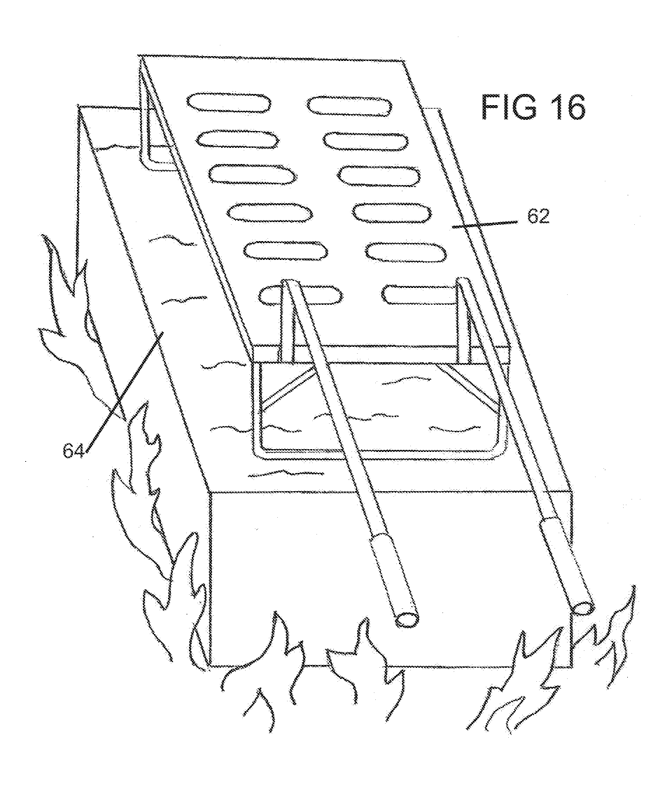

If the baking method is employed, it is not necessary for the mold material to be perforated. A solid sheet of 24 gage. stainless steel would be suitable for fabrication of the external and internal molds used in the baking process. FIG. 15 shows a handle 60 that can be used to position an assembly including a single tortilla 40 position in molds 50, 52 in hot oil for deep frying the tortilla 40 in an oval, conical configuration to form a single edible food container or shell 10. FIG. 16 shows a tray 62 having a plurality of slots in which the molds 50, 52, with a tortilla 40 therebetween, in a hot oil bath 62. The configuration of FIG. 16 could be used in a restaurant for batch operations, while the mold assembly of FIG. 15 would be suitable for cooking individual edible containers or shells 10.

The use of internal and external molds 50, 52 are required to establish the desired oval shape of the tortilla 40 as it is cooked to a rigid state forming the shell or container 10. If the deep frying process is used, then it is preferable that the molds be fabricated from a perforated sheet of stainless steel. These perforations 54 are indicated in FIG. 11. Stainless steel is a preferred material to be used in this application as it conducts heat well, is easy to clean, is more rigid than aluminum, and is not prone to rust. The perforations 54 are necessary to allow for the uninhibited flow of hot oil around the inner and outer sides of the tortilla 40 to ensure even cooking of the shell while submerged in the bath of hot oil.

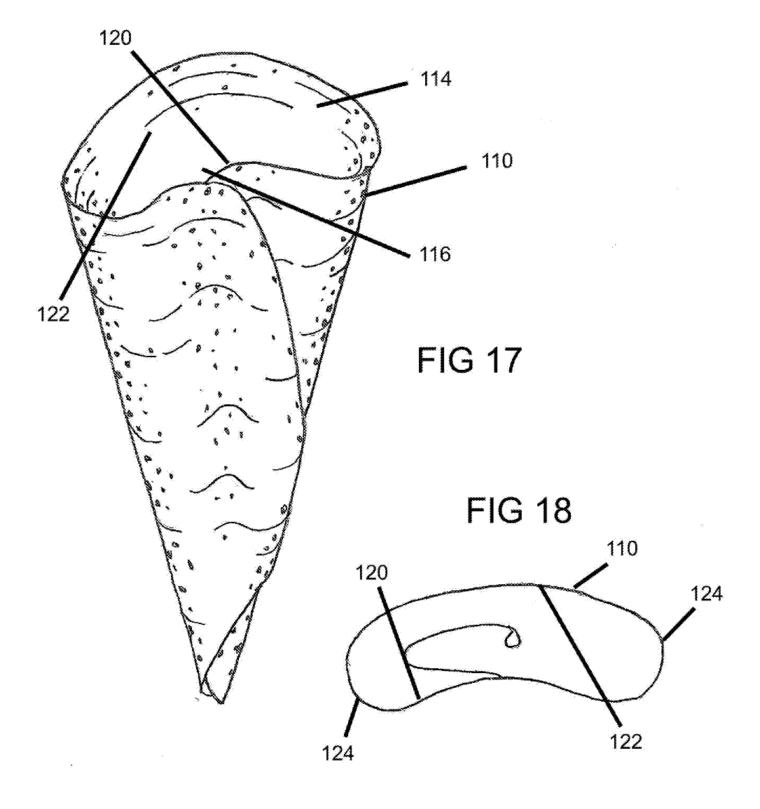

With minor modifications of the internal and external molds 50, 52, the tortilla may be formed into an oblong shell or edible container 110 having an arc shaped pocket 116 and open mount 114. The molds are bent so that the front is a convex shape and the back of the molds are concave, so that the shell will have a convex inner surface 120 on one side of the pocket 116 and an opposed concave inner surface 122 forming the other internal side of the pocket 116. FIG. 17 depicts a three dimensional view of the arch shaped taco shell or edible container 110 formed from a circular tortilla 40, which can have the same dimensions as the tortilla 40 used to form the shell or container 10, cooked to a rigid state and having an arc shaped oval top opening or mouth 114. The top view as seen in FIG. 18, depicts the taco shell or edible container 110 as the viewer is looking straight down into the top opening or mouth 114. The internal lines indicate where the edge 126 of the shell 10 overlaps and comes to a point at the bottom. The front side is convex and the back side is concave. The convex top edge 126 has an arc radius of three inches while the back top edge has an arc radius of four inches and the opposite sides are generally concentric. The depth of the top opening or mouth 114 measured front to back is one inch. Width of the top opening 114 measured along the center arc between opposite ends 124 is four inches. The opposite side edges 124 of the top opening are rounded with an arc radius of ½ inch, which is less than the radius of the convex and concave inner surfaces 120, 122. Height measured from bottom apex to top edge is eight inches, the same as the diameter of the circular tortilla being used. Overall dimensions of this arc shaped taco shell can be increased or decreased depending on choice of food content and customer preference.

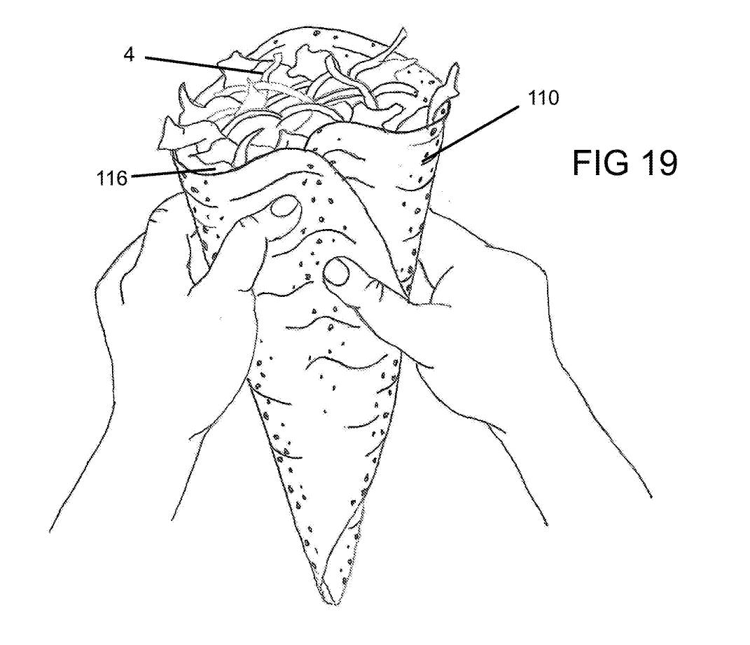

The arc shaped taco shell or edible container 110 provides an easy to handle product for both adults and children. The smaller hands of children often require them to use a two-handed method when gripping food products. FIG. 19 illustrates how a child would likely hold the arc shaped taco. This arc shape will not only conform to that shape of a user's hands, making the food product easier to hold, but will also more readily conform to a user's mouth than would a cone shaped taco shell or edible container that would have a circular cross section.

The edible containers, and especially the arc shaped edible container 110, can function not only as a receptacle to serve food items, but it can also be employed as a utensil, such as a spoon or ladle to pick up food items on a plate so that they can be eaten. For example, the edible container can be used with food items such as meat, beans, peas, rice, stews, snacks and leafy green vegetables, and an edible container can even be used for liquids, such as soup.

1. An edible container in which food items are disposable for consumption with the edible container which comprises: a tortilla, having an initially flat circular shape and a constant thickness, formed into a conical configuration with an oval cross section having a greater width than depth and expanding from a lower tip to an open mouth at an upper end, the tortilla being folded so that one side of the tortilla is folded over a second side of the tortilla with an edge of the one side extending from a front face to a rear face of the oval cross section, the first and second sides of the tortilla continuing to the open mouth with both of the folded first and second sides forming an upper front lip of the mouth that is lower than a rear, elevated lip of the mouth so that food items disposed in the edible container are visible and accessible over the folded first and second sides, but supportable by the rear, elevated lip of the edible container, wherein the oval shaped cross section conforms more closely to a human mouth than would a circular cross section so that it is easier to eat the edible container and food items in the edible container.

2. The edible container of claim 1 wherein the tortilla is sufficiently rigid to be held in place after being folded in the conical configuration with the oval cross section after the initially flat, circular tortilla is folded.

3. The edible container of claim 2 wherein the tortilla is fried to hold the tortilla in the conical configuration with the oval cross section.

4. The edible container of claim 3 wherein the tortilla is deep fried to rigidly hold the tortilla in the conical configuration with the oval cross section.

5. The edible container of claim 3 wherein the tortilla in a flat circular configuration is baked before being folded into the conical configuration with the oval cross section.

6. The edible container of claim 1 wherein the tortilla is baked after the initially flat tortilla is folded into the conical configuration with the oval cross section.

7. The edible container of claim 6 wherein the first and second sides when baked are restrained in the conical configuration with the oval cross section by external means.

8. The edible container of claim 1 wherein the edible container has the consistency of a taco shell.

9. The edible container of claim 1 wherein the front side and the rear side are both curved so that an inner surface of the front side is convex and an inner surface of the rear side is concave to form an arcuate shaped edible container to conform to both hands of a user when gripping the edible container.

10. A food product comprising an edible container formed from a tortilla, having an initially flat circular shape formed into a conical configuration with an oval cross section expanding from a lower tip to an open mouth at an upper end, the tortilla being folded so that one side of the tortilla is folded over a second side of the tortilla, folding of the first and second sides of the tortilla continuing to the open mouth with both of the folded first and second sides forming an upper front lip of the mouth lower than an intermediate central section forming a rear, elevated lip of the mouth so that food items disposed in the edible container are visible and accessible over the folded first and second sides, but supportable by the edible container in front of the rear, elevated lip, wherein the tortilla in the conical configuration with an oval cross section is cooked to have greater rigidity than the tortilla in the initially in the flat circular shape, and food items disposed in a pocket formed by the tortilla in the conical configuration with the oval cross section, the pocket being formed by parallel front and rear sides and an upper layer of the food item being visible and accessible in the mouth, wherein the oval shaped cross section conforms more closely to a human mouth than would a circular cross section so that it is easier to eat the edible container and food items in the edible container.

11. The food product of claim 10 wherein the oval cross section is an oblong cross section having a greater width than depth.

12. The food product of claim 10 wherein the oval cross section has a greater curvature adjacent opposite lateral ends and a flatter shape between opposite ends.

13. The food product of claim 10 wherein the first and second sides of the tortilla are both curved opposite curved ends of the oval cross section so that the open mouth of the edible is formed by one concave inner surface and one convex inner surface so that the edible container will conform to a user's hands when gripping the edible container while still conforming more closely to a human mouth than would a circular cross section so that it is easier to eat the edible container and food items in the edible container.

14. An edible container in which food items are disposable for consumption with the edible container, the edible container being formed for an initially flat piece of dough folded into an overlapping configuration having an open mouth, and having an oblong pocket extending from the open mount into which the food items are disposable, the oblong pocket having a concave inner surface extending between opposite ends of the oblong pocket, and a convex inner surface, spaced from the inner surface, and also extending between opposite ends of the oblong pocket, the concave inner surface and the convex inner surface being formed by portions of the piece of dough in the overlapping configuration, wherein the edible container conforms more closely to a human mouth than would a circular cross section so that it is easier to eat the edible container and food items in the edible container, and conforming to a user's hands when griping the edible container.

15. The edible container of claim 14 wherein the opposite ends of the oblong pocket have a greater curvature than the concave and convex inner surfaces.

16. The edible container of claim 15 wherein the concave and convex inner surfaces are concentric between opposite ends of the oblong pocket.

17. The edible container of claim 14 wherein the initially flat piece of dough comprises a tortilla.

18. The edible container of claim 14 wherein the tortilla is fried after being folded into an overlapping configuration between inner and outer molds and fried to form a stable rigid edible container.

19. The edible container of claim 14 where a first lip on the open mouth has a greater elevation than a second lip on the open mouth for retaining the food items with the food items being visible through the open mouth.

20. The edible container of claim 14 wherein the edible container has a conical shape and the oblong pocket is tapered from the mount to a tip of the edible container with cross sections of the edible container conforming to the oblong pocket.
